(19) United States
(12) Patent Application Publication
(10) Pub. No.: US 2008/0051180 A1
(43) Pub. Date: Feb. 28, 2008

(54) Slot machine and playing method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/648,556

(22) Filed: Jan. 3, 2007

Related U.S. Application Data
(60) Provisional application No. 60/840,016, filed on Aug. 25, 2006.

(51) Int. Cl. A63F 13/00

(52) U.S. Cl. 463/20

(57) ABSTRACT

It is intended to provide a slot machine in which a game is played in such a manner that, even though a combination of three left-to-right-directional arrangement ordered symbols on a pay line L does not coincide with any one of winning symbol combinations, a payout of a winning symbol combination is awarded to a player in case a combination of the three symbols rearranged in right-to-left directional arrangement order on the pay line L coincides with any one of winning symbol combinations.

### CROSS-REFERENCE TO THE RELATED APPLICATION (S)

This application is based upon and claims a priority from the U.S. provisional Patent Application No. 60/840,016 filed on Aug. 25, 2006, the entire contents thereof are incorporated herein by reference.

### BACKGROUND OF THE INVENTION

1. Field of the Invention

The present invention relates to a slot machine and playing method thereof in which a payout is awarded depending on a symbol combination consisting of repositioned symbols.

2. Description of Related Art

In conventional slot machines, a combination of symbols amongst plural symbols repositioned in a matrix is defined by symbols positioned on a pay line, and in case a symbol combination on the pay line coincides with a winning symbol combination, a payout associated with the winning symbol combination is awarded.

In this regard, a pay line generally passes through all of the columns in a matrix.

US Patent 6604999B2 and US Patent Application Publication No. 2002/0065124A1 disclose a gaming machine in which a special pay line which passes through fewer than all of the columns in a matrix is provided so as to enhance player's interest to games.

### SUMMARY OF THE INVENTION

The object of the present invention is to provide a slot machine and play method thereof which has new entertaining factors which conventional ones did not have inherently.

Therefore, in order to achieve the object, according to a first aspect of the present invention, there is provided a slot machine comprising: a display for displaying plural symbols on a pay line; and a game controller programmed to operate with the display (a) to cause the display to reposition plural symbols on the pay line, and (b) to award a payout of a winning symbol combination in case either a combination of the plural symbols on the pay line in a forward directional arrangement order or a combination of the plural symbols on the pay line in an inverse directional arrangement order coincides with a winning symbol combination.

Furthermore, according to a second aspect of the present invention, there is provided a slot machine comprising: a display for displaying plural symbols on a pay line; and a game controller programmed to operate with the display (a) to cause the display to reposition plural symbols on the pay line, (b) to award a payout of a winning symbol combination in case a combination of the plural symbols on the pay line in a forward directional arrangement order coincides with a winning symbol combination, and (c) to award a payout of a winning symbol combination in case the combination of the plural symbols on the pay line in the forward directional arrangement order does not coincides with a winning symbols combination and the game controller has finished (1) checking whether or not the combination of the plural symbols on the pay line in the inverse directional arrangement order coincides with a winning symbol combination, (2) causing the display to carry out an effect to make the plural symbols on the pay line flash sequentially in inverse directional arrangement order, and (3) obtaining a check result of (1) such that the combination of the plural symbols on the pay line in the inverse directional arrangement order coincides with a winning symbol combination.

Furthermore, according to a third aspect of the present invention, there is provided a slot machine comprising: a display for displaying plural symbols on a pay line; and a game controller programmed to operate with the display (a) to cause the display to reposition plural symbols on the pay line, (b) to award a payout of a winning symbol combination in case a combination of the plural symbols on the pay line in a forward directional arrangement order coincides with a winning symbol combination, and (c) to award a payout of a winning symbol combination in case the combination of the plural symbols on the pay line in the forward directional arrangement order does not coincides with a winning symbols combination and the game controller has finished (1) checking whether or not the combination of the plural symbols on the pay line in the inverse directional arrangement order coincides with a winning symbol combination, (2) causing the display to carry out an effect to reverse current arrangement order of the plural symbols on the pay line and to rearrange the plural symbols on the pay line in reversed order, and (3) obtaining a check result of (1) such that the combination of the plural symbols on the pay line in the inverse directional arrangement order coincides with a winning symbol combination.

Furthermore, according to a fourth aspect of the present invention, there is provided a slot machine comprising: a display for displaying plural symbols on a pay line; and a game controller programmed to operate with the display (a) to cause the display to reposition plural symbols on the pay line, (b) to award a payout of a winning symbol combination in case a combination of the plural symbols on the pay line in a forward directional arrangement order coincides with a winning symbol combination, and (c) to award a payout of a winning symbol combination in case the combination of the plural symbols on the pay line in the forward directional arrangement order does not coincides with a winning symbols combination and the game controller has finished (1) checking whether or not the combination of the plural symbols on the pay line in the inverse directional arrangement order coincides with a winning symbol combination, (2) causing the display to carry out an effect to make the plural symbols on the pay line flash sequentially in inverse directional arrangement order with reference to the pay line and further carry out an effect to reverse current arrangement order of the plural symbols on the pay line and to rearrange the plural symbols on the pay line in reversed order, and (3) obtaining a check result of (1) such that the combination of the plural symbols on the pay line in the inverse directional arrangement order coincides with a winning symbol combination.

Furthermore, according to a fifth aspect of the present invention, there is provided a method of playing a slot machine in which a game controller repeats a game by causing a display to display plural symbols on a pay line, the method comprising the steps of: (a) causing display to reposition plural symbols on the pay line by the game controller; and (b) awarding a pay out of winning symbol combination by the game controller in case either a combination of the plural symbols on the pay line in a forward directional arrangement order or a combination of the plural symbols on the pay line in an inverse directional arrangement order coincides with a winning symbol combination.

Furthermore, according to a sixth aspect of the present invention, there is provided a method of playing a slot machine in which a game controller repeats a game by causing a display to display plural symbols on a pay line, the method comprising the steps of: (a) causing display to reposition plural symbols on the pay line by the game controller; (b) awarding a payout of a winning symbol combination in case a combination of the plural symbols on the pay line in a forward directional arrangement order coincides with a winning symbol combination by the game controller, and (c) awarding a payout of a winning symbol combination by the game controller in case the combination of the plural symbols on the pay line in the forward directional arrangement order does not coincides with a winning symbols combination and the game controller has finished (1) checking whether or not the combination of the plural symbols on the pay line in the inverse directional arrangement order coincides with a winning symbol combination, (2) causing the display to carry out an effect to make the plural symbols on the pay line flash sequentially in inverse directional arrangement order, and (3) obtaining a check result of (1) such that the combination of the plural symbols on the pay line in the inverse directional arrangement order coincides with a winning symbol combination.

Furthermore, according to a seventh aspect of the present invention, there is provided A method of playing a slot machine in which a game controller repeats a game by causing a display to display plural symbols on a pay line, the method comprising the steps of: (a) causing display to reposition plural symbols on the pay line by the game controller; (b) awarding a payout of a winning symbol combination by the game controller in case a combination of the plural symbols on the pay line in a forward directional arrangement order coincides with a winning symbol combination, and (c) awarding a payout of a winning symbol combination by the game controller in case the combination of the plural symbols on the pay line in the forward directional arrangement order does not coincides with a winning symbols combination and the game controller has finished (1) checking whether or not the combination of the plural symbols on the pay line in the inverse directional arrangement order coincides with a winning symbol combination, (2) causing the display to carry out an effect to reverse current arrangement order of the plural symbols on the pay line and to rearrange the plural symbols on the pay line in reversed order, and (3) obtaining a check result of (1) such that the combination of the plural symbols on the pay line in the inverse directional arrangement order coincides with a winning symbol combination.

Furthermore, according to an eighth aspect of the present invention, there is provided A method of playing a slot machine in which a game controller repeats a game by causing a display to display plural symbols on a pay line, the method comprising the steps of: (a) causing display to reposition plural symbols on the pay line by the game controller; (b) awarding a payout of a winning symbol combination by the game controller in case a combination of the plural symbols on the pay line in a forward directional arrangement order coincides with a winning symbol combination, and (c) awarding a payout of a winning symbol combination by the game controller in case the combination of the plural symbols on the pay line in the forward directional arrangement order does not coincides with a winning symbols combination and the game controller has finished (1) checking whether or not the combination of the plural symbols on the pay line in the inverse directional arrangement order coincides with a winning symbol combination, (2) causing the display to carry out an effect to make the plural symbols on the pay line flash sequentially in inverse directional arrangement order with reference to the pay line and further carry out an effect to reverse current arrangement order of the plural symbols on the pay line and to rearrange the plural symbols on the pay line in reversed order, and (3) obtaining a check result of (1) such that the combination of the plural symbols on the pay line in the inverse directional arrangement order coincides with a winning symbol combination.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

In the drawings,

FIG. 1 is a diagram for illustrating a feature of typical game developments that may be encountered in accordance with the principles of the present invention;

FIG. 2 is a perspective view showing an outline construction of the slot machine;

FIG. 3 is an exemplary diagram of symbol columns depicted on reel band of respective reels of the slot machine;

FIG. 4 is an exemplary block diagram showing a control system of the slot machine;

FIG. 5 is a payout table showing winning symbol combinations and payouts associated with the respective winging symbol combinations applied during a base game;

FIG. 6 is a diagram depicting what is displayed in a lower-side image display panel;

FIG. 7 is a diagram depicting what is displayed in the lower-side image display panel;

FIG. 8 is a flowchart of a main control program;

FIG. 9 is a flowchart of a main game processing program; and

FIG. 10 is a flowchart of a symbol display control processing program.

### DETAILED DESCRIPTION OF THE PREFERRED EMBODIMENTS

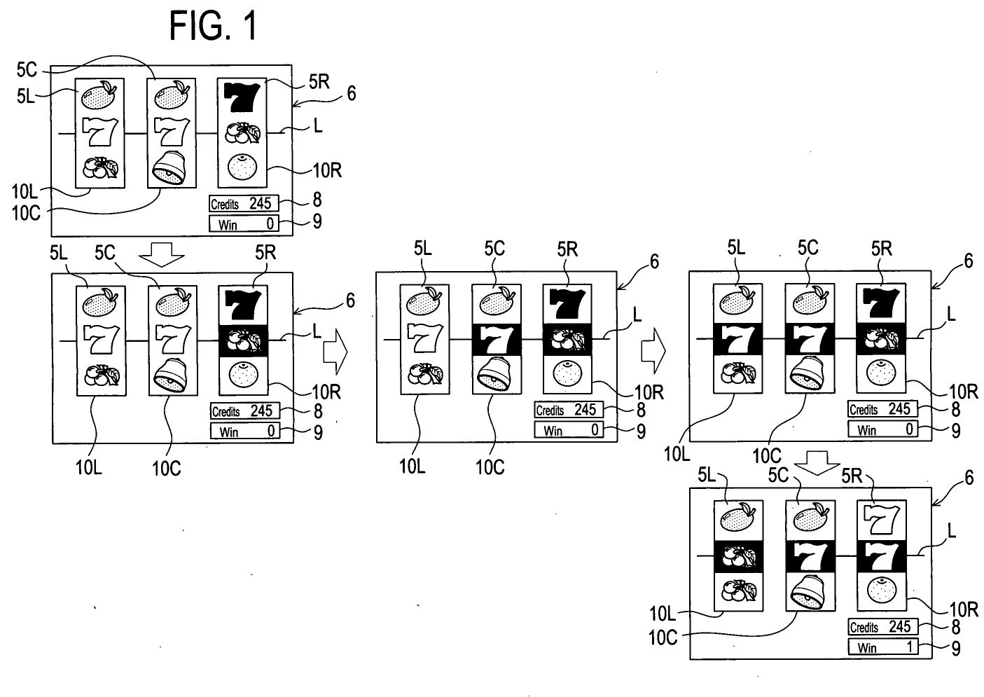

FIG. 1 is a diagram for illustrating a feature of typical game developments that may be encountered in accordance with the principles of the present invention.

In the slot machine directed to the present embodiment, as shown in FIG. 1, a lower-side image display panel 6 is a video display and displays three display windows 10L, 10C, and 10R all of which are visible. Through each of the display windows 10L, 10C, and 10R, three symbols depicted on respective reel bands of the reels 5L, 5C, and 5R are positioned in a form of three rows in a column. Accordingly, in the lower-side image display panel 6, nine symbols in total are positioned in a form of 3 rows×3 columns matrix. Furthermore, in the lower-side image display panel 6, there is formed a pay line L which runs across the three display windows 10L, 10C, and 10R horizontally. The pay line L defines a combination of symbols in a forward direction, namely, a left-to-right direction thereon. Furthermore, a credit amount display section 8 and a payout amount display section 9 are provided at the lower part of the lower-side image display panel 6. There have previously been determined various winning symbol combinations which are defined in the forward (left-to-right) directional arrangement order.

The reels 5L, 5C, and 5R virtually spin and stop whereby, three symbols, three rows in a column, are repositioned in each of the display windows 10L, 10C, and 10R. In case a combination of three symbols repositioned on the pay line L coincides with a certain winning symbol combination, a payout of the winning symbol combination is awarded to a player.

However, even if a combination of three symbols repositioned on the pay line L does not coincide with any one of winning symbol combinations, a payout of a winning symbol combination is awarded to a player in case inversed directional arrangement order, i.e., left-to-right directional arrangement order with reference to the pay line L, of the three symbols on the pay line L coincides with any one of inverse (right-to-left) directional arrangement ordered winning symbol combinations.

For showing an inverse (right-to-left) directional arrangement ordered winning symbol combination, effects such as shown in FIG. 1 are carried out in the lower-side image display panel 6.

That is, an upper stage in FIG. 1 shows an exemplary case in which a current symbol combination repositioned on the pay line L does not coincide with any one of winning symbol combinations but an inverse (right-to-left) directional arrangement order of the current symbol combination does coincide with any one of inverse (right-to-left) directional arrangement ordered winning symbol combinations.

In the exemplary case, as shown in at a middle stage of FIG. 1, there is carried out an effect to make the three symbols repositioned on the pay line L flash one by one from the inverse (right-to-left) directional arrangement order. Subsequent to this effect, as shown at a lower stage of FIG. 1, there is further carried out an effect to reverse arrangement order of the three symbols on the pay line L, whereby only the three symbols on the pay line L are repositioned.

The effect as shown at the lower stage of FIG. 1 is an effect to reverse only the three forward (left-to-right) directional arrangement ordered symbols on the pay line L and reposition them on the pay line L in reversed order. Furthermore, the lower stage of FIG. 1 shows the three symbols on the pay line L keep flashing. In this regard, the effect to make the three symbols flash may be stopped when the effect directed to the lower stage is carried out. Furthermore, at the middle and lower stags of FIG. 1, background of a symbol is made to flash. However, instead of background, a symbol itself may be made to flash in the effect.

The embodiment of the present invention will be described in detail by referring to the drawings.

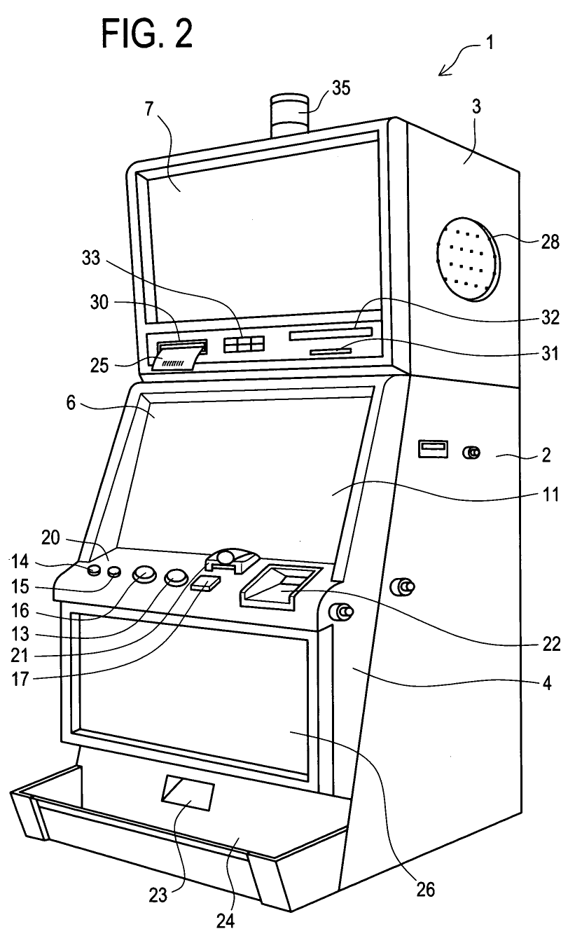

Firstly, schematic structure of a slot machine 1 directed to the embodiment will be described by referring to FIG. 2. FIG. 2 is a perspective view showing an outline construction of the slot machine 1.

The slot machine 1 directed to the present embodiment includes: a cabinet 2; a top box 3 arranged above of the cabinet 2; and a main door 4 provided on a front face of the cabinet 2.

An upper-side image display panel 7 is provided on a front face of the top box 3. The upper-side image display panel 7 is structured with a well-known crystal liquid panel which usually displays demonstration animation, information about the slot machine such as game rules, payout table, and the like.

A lower-side image display panel 6 is provided on the main door 4.

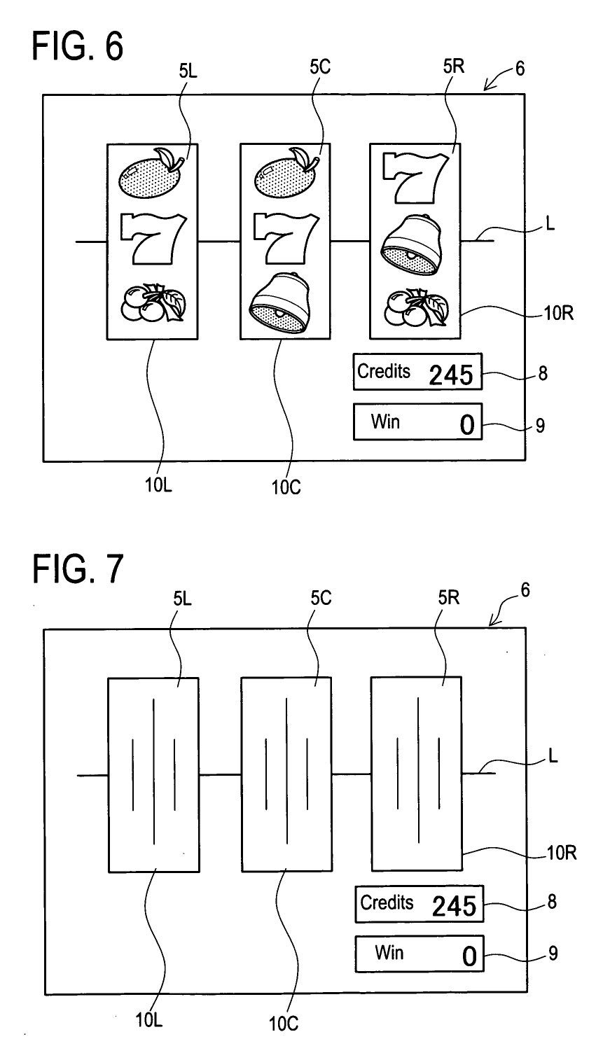

Here will be described game-related images to be displayed in the lower-side image display panel 6 of the slot machine 1. As examples of game-related images, FIG. 6 and FIG. 7 depict what are displayed in the lower-side image display panel 6. During a base game, as shown in FIG. 6 and FIG. 7, there are visibly displayed symbols depicted on reel bands of the reels 5L, 5C, and 5R through the display windows 10L, 10C, and 10R, respectively, in the lower-side image display panel 6. FIG. 6 shows a state that symbols depicted on respective reel bands of the reels 5L, 5C, and 5R are positioned or repositioned. FIG. 7 shows a state that reels 5L, 5C, and 5R are virtually spinning.

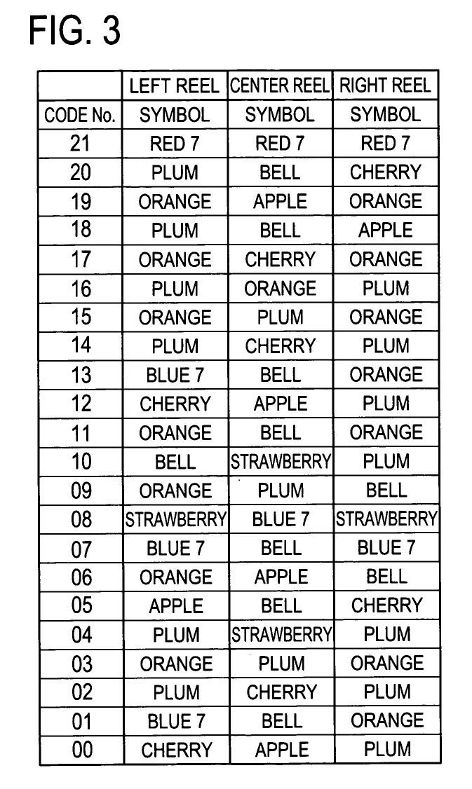

It is to be noted that a symbol column consisting of twenty-two symbols is depicted on reel bands of respective reels 5L, 5C, and 5R (see FIG. 3).

Furthermore, a touch panel 11 (see FIG. 2) is provided on a front face of the lower-side image display panel 6, whereby a player can input various instructions with the touch panel 11.

Furthermore, a credit amount display section 8 and a payout amount display section 9 are provided in the lower-side image display panel 6. The credit amount display section 8 displays amount of credits the player currently holds. The payout amount display section 9 displays amount of payout to be awarded in case a symbol combination repositioned on the pay line L coincides with a certain winning symbol combination and amount of payouts won by a bonus game.

That is, the three display windows 10L, 10C, and 10R are made visible and displayed in the lower-side image display panel 6, and in the display windows 10L, 10C, and 10R, three symbols, three rows in a column, depicted on reel bands of respective reels 5L, 5C, and 5R are positioned.

As shown in FIG. 6 and FIG. 7, there is formed the pay line L which runs across the three display windows 10L, 10C, and 10R horizontally in the lower-side image display panel 6. The pay line L is to define a combination of three symbols in forward (left-to-right) directional arrangement order.

It is to be noted that, during a bonus game, predetermined bonus game images are displayed together with the credit amount display section 8 and the payout amount display section 9 in a state that images of the display windows 10L, 10C, and 10R (including the reels 5L, 5C, and 5R) and the pay line L are erased out.

Back to FIG. 2, below the lower-side image display panel 6, there are provided a control panel 20 which consists of plural buttons with which a player inputs instructions concerning game progress, a coin insertion slot 21 for accepting coins, gaming media, in the cabinet 2, and a bill validator 22.

The control panel 20 includes a spin button 13, a change button 14, a CASHOUT button 15, a 1-BET button 16 and a MAX-BET button 17. The spin button 13 is operation means for inputting an instruction to let the reels 5L, 5C, and 5R start spinning. The change button 14 is operation means for asking a shop keeper of money changing. The CASHOUT button 15 is operation means for inputting an instruction to pay out coins equivalent to the amount of credits a player has earned (1 coin for 1 credit) to a coin tray 24 through a coin payout opening 23 or for inputting an instruction to pay out credits in a form of bar-code ticket 25 to be described later.

The 1-BET button 16 is operation means for accepting an instruction to wager 1 credit upon a game out of all the credits a player has held. The MAX-BET button 17 is operation means for accepting an instruction to wager maximum number of credits (50 credits is the maximum number in the present embodiment) a player can wager upon per one game out of all the credits the player has held.

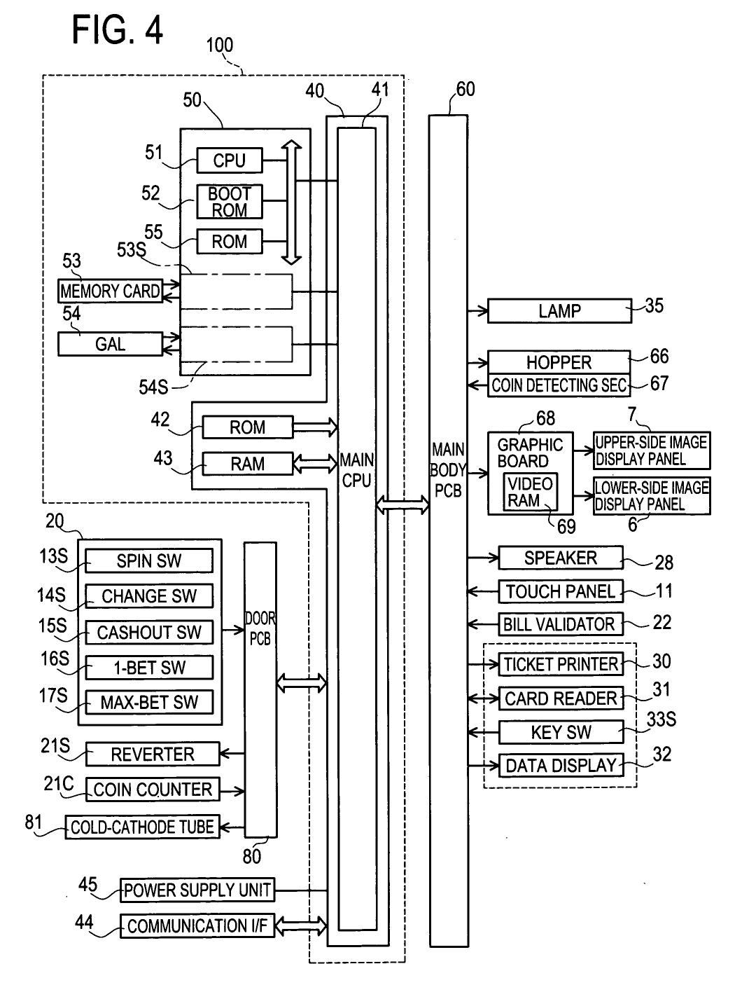

Inside of the coin insertion slot 21, a reverter 21S and a coin counter 21C (see FIG. 4 for both) are provided. The reverter 21S discriminates forgery of coins and expels improper coins from the coin payout opening 23. The coin counter 21C detects proper coins accepted by the coin counter 21C and counts the number of them.

The bill validator 22 discriminates counterfeit bills and accepts authentic bills into the cabinet 2. Bills inserted in the cabinet 2 are converted into the number of coins and credits equivalent to the converted number of coins are added to credits the player should hold. Incidentally, the bill validator 22 is able to read a bar-code ticket 25 to be described later. On a lower front face of the main door 4, i.e., a lower portion of the control panel 20, there is provided a glass panel 26 on which character(s) of the slot machine 1 or the like is depicted.

As to the slot machine 1 directed to the present embodiment, coins, bills, or electric valuable information (credit) corresponding to coins and bills are used as gaming media. However, in the present invention, types of gaming media are not restricted to the above. For example, medal, token, electric money, ticket, and the like are applicable as gaming media.

Below the upper-side image display panel 7, a ticket printer 30, a card reader 31, a data display 32 and a key pad 33 are provided.

The ticket printer 30 is a printing device for printing a bar-code on a ticket in which data of the amount of credits, a date, an identification number of the slot machine 1, and the like are encoded, and outputting such a ticket as bar-code ticket 25. A player gets other gaming machine read the outputted bar-code ticket 25 so as to play a game with the target gaming machine or to take certain procedures at a certain section in a game arcade (e.g., a cashier in a casino).

The card reader 31 is to read data from a smart card and, vice versa, to write data in a smart card. A smart card is a card a player should bring with him/her and, for example, data concerning game history of the player, and the like are recorded thereon.

The data display 32 is made of fluorescent display or the like and displays data read by the card reader 31 and data inputted by a player with the key pad 33, for example. The key pad 33 is used for inputting instructions and data concerning issuance of ticket and the like. Furthermore, a lamp 35 is provided on a top face of the top box 3. The lamp 35 is turned on and flashes in a predetermined manner so as to summon a shop keeper when an error occurs to the slot machine 1.

Incidentally, “28” is a speaker.

Next, by referring to FIG. 3, there will be described symbols depicted on reel bands of respective reels 5L, 5C and 5R, which are scrolled and repositioned in the display windows 10L, 10C, and 10R in the lower-side image display panel 6 during a game. FIG. 3 shows exemplary symbol columns depicted on reel bands of respective reels 5L, 5C, and 5R.

Twenty-two symbols are depicted on reel bands of left reel 5L, the center reel 5C, and the right reel 5R. Each symbol column is made by combining “RED7”, “BLUE7”, “BELL”, “CHERRY”, “STRAWBERRY”, “PLUM”, “ORANGE”, and “APPLE”. As shown in FIG. 3, the above mentioned symbols are positioned on reel bands of respective reels 5L, 5C, and 5R in individually different orders and combinations.

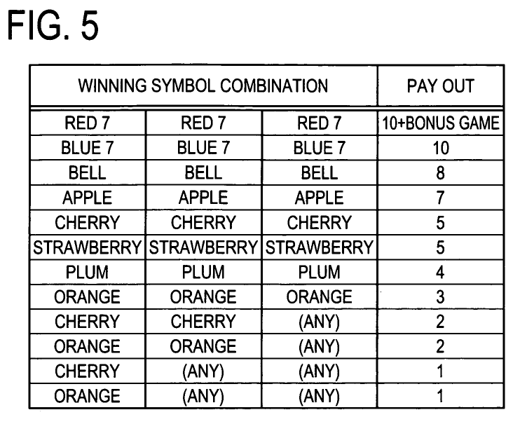

As to symbols “BLUE7”, “BELL”, “CHERRY”, “STRAWBERRY”, “PLUM”, “APPLE”, and “ORANGE, when three identical symbols out of the above are repositioned on the pay line L, predetermined amount of payout is awarded to a player (see FIG. 5). Furthermore, as to “CHERRY” and “ORANGE”, even though only one or identical two of them is/are repositioned on the pay line L, predetermined amount of payout is awarded to a player depending on the number of the symbol(s) on the pay line L (see FIG. 5).

In case three “RED7” symbols are repositioned on the pay line L, predetermined amount of payout is awarded to a player and a bonus game occurs. Games to be carried out by the slot machine 1 directed to the present embodiment consist of two game modes, namely, base game and bonus game. A base game is played in such a manner that a player aims to reposition a certain symbol combination on the pay line L and the reels 5L, 5C, and 5R are used therein. On the other hand, a bonus game is played in such a manner that three jewelry boxes as choices are indicated in the lower-side image display panel 6, and then, a game directed to player's choice of a jewelry box associated with payout amount is carried out. Details of the bonus game will be omitted here.

A part of respective symbol columns depicted on reel bands of the reels 5L, 5C, and 5R, shown in FIG. 3, is displayed through corresponding display widows 10L, 10C and 10R. That is, three symbols, three rows in a column, are repositioned and displayed through each of the display windows 10L, 10C, and 10R and nine symbols in total are positioned. After the 1-BET button 16 or the MAX-BET button 17 is operated to designate the number of bets and the spin button 13 is pressed, symbol columns depicted on reel bands of respective reels 5L, 5C, and 5R in scroll from top to bottom are displayed through the corresponding display windows 10L, 10C, and 10R (see FIG. 7). After a predetermined time lapses, the reels 5L, 5C, and 5R stop spinning and a part of respective symbol columns of the reels 5L, 5C, and 5R is displayed through corresponding display windows 10L, 10C, and 10R. That is, three symbols, three rows in a column, are repositioned and displayed through each of the display windows 10L, 10C, and 10R, thereby nine symbols in total are repositioned (see FIG. 6). Furthermore, various winning symbol combinations (see FIG. 5) based on a forward directional arrangement order (left-to-right directional arrangement order) are previously determined. In case a symbol combination on the pay line L coincides with a certain winning symbol combination, payout for the winning symbol combination is awarded to a player.

Next, there will be described a control system of the slot machine 1 directed to the present embodiment by referring to FIG. 4. FIG. 4 is a block diagram showing a control system of the slot machine 1 schematically.

As shown in FIG. 4, the control system of the slot machine 1 basically consists of a mother board 40 and a gaming board 50.

The gaming board 50 comprises: a CPU 51, a ROM 55, a boot ROM 52, connected to one another by internal bus; a card slot 53S for accepting a memory card 53; and an IC socket 54S compatible with GAL (Generic Array Logic) 54.

The memory card 53 is a non-volatile memory which is a recording medium to store a game program and a game system program (termed as game program and the like, hereafter) therein. The game program stored in the memory card 53 includes a lottery program. The lottery program is to choose a symbol from respective symbol columns of the reels 5L, 5C, and 5L and determine three symbols to be repositioned on the pay line L, (i.e., determine code numbers corresponding to respective symbols to be repositioned on the pay line L). The lottery program also includes symbol weight data associated with plural kinds of payout rate (e.g., 80%, 84%, 88%). The symbol weight data is data to associate code numbers of respective symbols (see FIG. 3) with one or plural random numbers belonging to a predetermined numerical value range (0˜255) with respect to each of the three reels 5L, 5C, and 5R. That is, one or plural random numbers is/are associated with a code number of a symbol. A random number is extracted through a lottery, whereby a symbol specified with the extracted random number(s) is repositioned.

Payout rate is determined in accordance with payout rate setting data outputted from the GAL 54 and a lottery is carried out in accordance with the symbol weight data associated with the payout rate.

The card slot 53S is structured such that a memory card 53 can be inserted in and pulled out from there, and connected to the mother board 40 with IDE bus. Therefore, kinds of games and rules to be executed with the slot machine 1 can be changed by rewriting and changing contents of a game program and the like stored in the memory card 53 to other ones. Kinds of games and rules to be executed with the slot machine 1 can be also changed by replacing a memory card 53 which stores a game program and the like with other memory card 53 which stores other game program and the like.

Game program includes: a program concerning game progress; image data and sound data to be outputted during a game; image data of symbols depicted on reel bands of the respective reels 5L, 5C, and 5R; image data concerning game rules, payout table, and the like; and demonstration image data.

The GAL 54 is a kind of PLD which has OR-fixed type array structure. The GAL 54 has plural input ports and output ports and when certain data is inputted to an input port, data associated with the inputted data is outputted from an output port. The data outputted from the output port is the afore-mentioned payout setting data.

The IC socket 54S is structured such that the GAL 54 can be attached to and detached from there, and connected to the mother board 40 with PCI bus. Therefore, payout rate setting data to be outputted from the GAL 54 can be changed by writing over program to be stored in the detached GAL 54 or changing a GAL 54 with other GAL 54.

The CPU 51, the ROM 55 and the boot ROM 52 connected to one another with internal bus are connected to the mother board 40 with PCI bus. The PCI bus transmits signals between the mother board 40 and the gaming board 50 and supplies power from the mother board 40 to the gaming board 50. The ROM 55 stores country identification information and an authentication program. The boot ROM 52 stores an auxiliary authentication program, a program (boot code) with which the CPU 51 can activate the auxiliary authentication program, and the like.

The authentication program is a program (falsification-check program) for authenticating a game program and the like. The authentication program is described along falsification-check procedure of the game program and the like which is subject to an authentication-fetch processing. The auxiliary authentication program is a program for authenticating the afore-mentioned authentication program and is described along falsification-check procedure of the authentication program which is subject to an authentication processing.

Next, there will be described the mother board 40. The mother board 40 is constituted by a commercially available and versatile mother board (printed-wiring board on which essential parts of a personal computer are mounted), and equipped with a main CPU 41, a ROM 42, and a RAM 43.

The ROM 42 consists of a memory device such as flash memory or the like, and stores programs such as BIOS to be executed by the main CPU 41, and permanent data such as lottery tables of base game and bonus game, payout table (see FIG. 5), and the like. When the BIOS is executed by the main CPU 41, an initialization processing for certain peripheral devices is carried out and a fetch processing for fetching game program and the like is started through the gaming board 50.

The RAM 43 stores data and programs to be used when the main CPU 41 operates. The RAM 43 can store various programs to be read out through the gaming board 50, namely, the authentication program, the game program and the like, and various information such as amount of credits a player currently holds and the like.

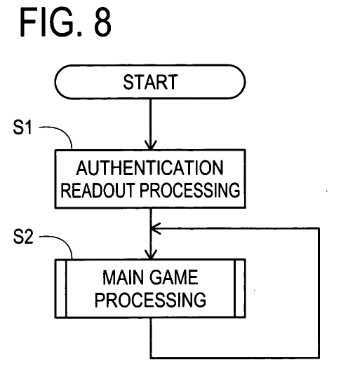

A communication interface 44 is connected to the mother board 40. The communication interface 44 is a communicating device for communicating with a server or the like installed in a game arcade through a communication line. The slot machine 1 communicates with a server or the like through the communication interface 44 to transmit bet information, a lottery result of a base-game lottery processing and the like which are dealt in a main game processing (see S2 in FIG. 8) to be described later.

A main body PCB 60 and a door PCB 80 both described later are separately connected to the mother board 40 with USB. Furthermore, a power supply unit 45 is connected to the mother board 40. When power is supplied to the mother board 40 from the power supply unit 45, the main CPU 41 in the mother board 40 is activated and at the same time, power is supplied to the gaming board 50 through PCI bus, whereby the CPU 51 is activated.

A game controller 100 is constituted by the mother board 40 and the gaming board 50.

On the other hand, devices for generating input signals to be inputted to the game controller 100 and devices of which operations are controlled by control signals outputted from the game controller 100 are connected to the main body PCB 60 and the door PCB 80. The game controller 100 executes the game program and the like stored in the RAM 43 in accordance with an input signal inputted to the game controller 100. Carrying out a certain processing operation, the game controller 100 stores a processing result in the RAM 43 and carries out control operation of various devices.

The lamp 35, the hopper 66, the coin detecting section 67, the graphic board 68, the speaker 28, the touch panel 11, the bill validator 22, the ticket printer 30, the card reader 31, the key switch 33S, and the data display 32 are connected to the main body PCB 60.

The touch panel 11 is provided on a front face of the lower-side image display panel 6. The touch panel 11 is capable of specifying a position in a coordinate touched by a player, and detecting a portion the player touched and which direction the touched portion has moved in accordance with the specified coordination position information.

The hopper 66 is provided inside of the cabinet 2 and pays out predetermined number of coins to the coin tray 24 through the coin payout opening 23 in accordance with a control signal outputted from the game controller 100. The coin detecting section 67 outputs an input signal to the game controller 100 when detecting payout of predetermined number of coins from the coin payout opening 23.

A graphic board 68 controls image display at the upper-side image display panel 7 and the lower-side image display panel 6 in accordance with a control signal outputted from the game controller 100. For example, amount of player's credits stored in the RAM 43 is displayed at the credit amount display section 8. Furthermore, amount of credits to be awarded as payouts is displayed at the payout amount display section 9.

The graphic board 68 is equipped with a VDP (Video Display Processor) for generating image data in accordance with control signals outputted from the game controller 100, a video RAM 69 for temporarily storing image data generated by the VDP, and the like. It is to be noted that image data used when generating image data with the VDP is included in the game program.

The graphic board 68 also controls motion image of the reels 5L, 5C, and 5R, namely, spinning and stopping of the reels 5L, 5C, and 5R, displayed in the lower-side image display panel 6 (see FIG. 1, FIG. 6, and FIG. 7) in accordance with control signals from the game controller 100.

Furthermore, the bill validator 22 discriminates forgery of a bill and a bar-code ticket 25 and accepts proper bill and bar-code ticket 25 into the cabinet 2. When accepting a proper bill, the bill validator 22 outputs an input signal to the game controller 100 based on value of the accepted bill. Furthermore, the bill validator 22 outputs an input signal to the game controller 100 based on the number of coins recorded in the proper bar-code ticket 25.

The ticket printer 30 prints a bar code in which data regarding amount of credits stored in the RAM 43 and the like are encoded in accordance with a control signals outputted from the game controller 100, and outputs the encoded data as bar-code ticket 25.

The card reader 31 reads data from a smart card to send it to the game controller 100 or writes data on a smart card in accordance with a control signal from the game controller 100. The key switch 33S is provided on the key pad 33 and outputs a certain input signal to the game controller 100 when the key pad 33 is operated by a player. The data display 32 displays data read out by the card reader 31 and data inputted by a player through the key pad 33 in accordance with a control signal outputted from the game controller 100.

A control panel 20, a reverter 21S, a coin counter 21C and a cold-cathode tube 81 are connected to the door PCB 80. The control panel 20 is equipped with a spin switch 13S directed to the spin button 13, a change switch 14S directed to the change button 14, a CASHOUT switch 15S directed to the CASHOUT button 15, a 1-BET switch 16S directed to the 1-BET button 16, and a MAX-BET switch 17S directed to the MAX-BET button 17. Each of the switches 13S through 17S outputs a signal to the game controller 100 when corresponding buttons are operated by a player.

The coin counter 21C is provided inside of the coin insertion slot 21 and discriminates forgery of a coin inserted in the coin insertion slot 21 by a player. Improper coins are ejected from the coin payout opening 23. The coin counter 21C outputs an input signal to the game controller 100 when detecting a proper coin.

The reverter 21S operates in accordance with a control signal outputted from the game controller 100 and divides and distributes coins discriminated as proper by the coin counter 21C to a cash box (not shown) or the hopper 66 both installed inside of the slot machine 1. The cold-cathode tube 81 works as back light arranged on rear-face sides of the lower-side image display panel 6 and the upper-side image display panel 7 and flashes in accordance with a control signal outputted from the game controller 100.

Next, by referring to FIG. 5, there will be described winning symbol combinations and payouts for them in case a base game is carried out with the slot machine 1 in which the reels 5L, 5C, and 5R are used. FIG. 5 is a payout table showing winning symbol combinations and payouts for the respective winning symbol combinations in case a base game is carried out by using the reels 5L, 5C, and 5R.

It is to be noted that numerals indicated in the “PAYOUT” column are amount of payouts to be awarded per “1” bet. Therefore, in case the number of bets is “1”, payout value as shown in FIG. 5 is added to player's credits, and in case the number of bets is “2” or larger, a multiple of the number of bets on the payout value as shown in FIG. 5 is added to player's credits.

For example, in case of winning a bonus game trigger, three “RED7” symbols are repositioned on the pay line L and 10 credits per 1-bet are awarded as payout and a bonus game occurs.

In case of a winning symbol combination consisting of three “BLUE7” symbols, three “BLUE7” symbols are repositioned on the pay line L and 10 credits per 1-bet are awarded as payout.

In case of a winning symbol combination consisting of three “BELL” symbols, three “BELL” symbols are repositioned on the pay line L and 8 credits per 1-bet are awarded as payout.

As to other winning symbol combinations listed therein, respective winning possibilities and amount of payouts per 1-bet have been set as shown in FIG. 5. However, in case a symbol combination repositioned on the pay line L does not coincide with any one of the winning symbol combinations shown in FIG. 5, it is a loss of a game and no credits are awarded.

However, in case one or two of “ORANGE” symbol(s) or “CHERRY” symbol(s) is/are repositioned on the pay line L, a special rule is applied. To be more specific, even if a forward (left-to-right) directional arrangement ordered symbol combination does not coincide with a one-or-two-“ORANGE”-or-“CHERRY”-symbol(s)-related winning symbol combination defined in forward (left-to-right) directional arrangement order shown in FIG. 5 (in other words, it is a loss of a game with reference to forward directional arrangement order), 1 or 2 credit(s) per 1-bet is/are awarded as payout for the symbol combination in case inverse (right-to-left) directional arrangement order of the symbol combination on the pay line L coincides with any one of one-or-two-“ORANGE”-or-“CHERRY”-symbol(s)-related winning symbol combinations defined in inverse (right-to-left) directional arrangement order.

Next, there will be described main control program to be executed in the slot machine 1 of the present embodiment by referring to drawings. FIG. 8 is a flowchart of a main control program.

It is to be noted that, before the main control program is executed, the memory card 53 has been inserted in the card slot 53S of the gaming board 50 and the GAL 54 has been attached to the IC socket 54S.

When power is turned on at the power supply unit 45, the game controller 100 is activated and an authentication readout processing is carried out at S1. In the authentication readout processing, the mother board 40 and gaming board 50 both of which constitute the game controller 100 carry out their respective processing procedures separately and simultaneously.

That is, in the gaming board 50, the CPU 51 reads out the auxiliary authentication program stored in the boot ROM 52 and carries out auxiliary authentication in accordance with the auxiliary authentication program to verify and prove that no falsification of the program is found before fetching the program to the mother board 40.

On the other hand, in the mother board 40, the main CPU 41 executes the BIOS stored in the ROM 42, and gets compressed data included in the BIOS decompressed into the RAM 43, thereby to execute the BIOS decompressed into the RAM 43 and to carry out diagnosis and initialization of various peripheral devices.

After that, the game controller 100 reads out the authentication program stored in the ROM 55 and verifies and authenticates that the no falsification is found in the game program and the like stored in the memory card 53 inserted in the card slot 53S. After the authentication processing completes normally, the game controller 100 writes and stores the authenticated game program and the like in the RAM 43, and then, obtains payout rate setting data and country identification information.

After completion of the above procedures, the game controller 100 completes the authentication readout processing.

In S2, the game controller 100 sequentially reads out and executes the game program and the like authenticated at the authentication readout processing of S1 thereby to carry out a main game processing. By carrying out the main game processing, a game directed to the present embodiment is carried out with the slot machine 1. The main game processing is repeatedly carried out while power is supplied to the slot machine 1.

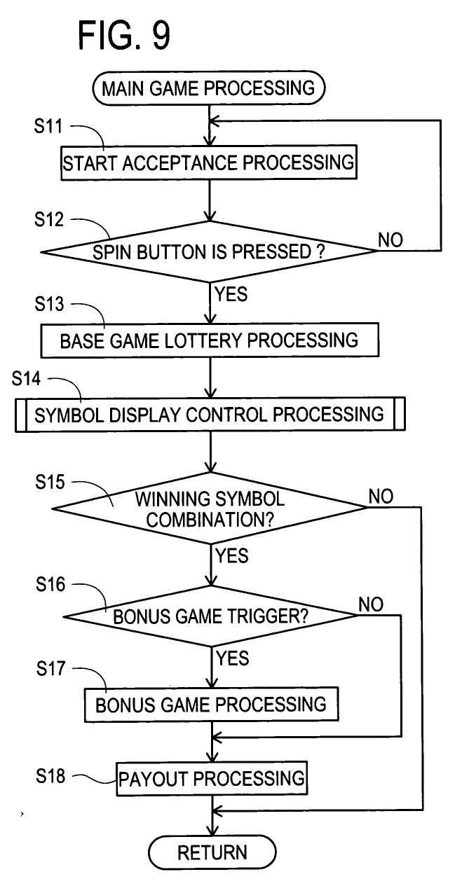

Next, there will be described a subroutine concerning the main game processing of S2 by referring to FIG. 9.

FIG. 9 shows the flowchart of the main game processing to be carried out in the slot machine 1 directed to the present embodiment. It is to be noted that programs indicated in the flowchart are stored in the ROM 42 or RAM 43 and executed by the game controller 100.

As shown in FIG. 9, the game controller 100 firstly carries out a start acceptance processing at S11 in which an inserted coin is accepted and the number of bets on the pay line L is set after predetermined initialization setting. At the start acceptance processing, insertion of a coin and bet operation with the 1-BET button 16 or the MAX-BET button 17 are done by a player.

Next, the controller 100 judges whether or not the spin button 13 has been pressed at S12. For judging presence or absence of an input from the spin button 13, the game controller 100 detects whether or not to receive an input signal outputted from the spin switch 13S.

In case the spin button 13 is not pressed on (S12: NO), the processing returns to the start acceptance processing (S11) again. Under this state, a player can change the number of bets or the like by operating bet buttons. In case the spin button 13 is pressed on (S12: YES), the number of bets on the pay line L set by operating the 1-BET button 16 and the MAX-bet button 17 is subtracted from amount of credits a player currently holds, and stored in the RAM 43 as bet information.

After entering into S13, the game controller 100 carries out a base game processing in which the reels 5L, 5C, and 5R are used.

In S13, the game controller 100 carries out a base game lottery processing.

To be more specific, the game controller 100 executes a random number generating program included in the lottery program stored in the RAM 43, whereby a random number value is selected for each of the reels 5L, 5C, and 5R from a numerical value range (0˜255). Next, the game controller 100 refers to symbol weight data (see FIG. 3) associated with the payout rate setting data and determines code numbers of the respective reels 5L, 5C, and 5R in accordance with selected three random number values. After the determined code numbers of the reels 5L, 5C, and 5R are stored in the RAM 43, the processing goes on to S14.

The determined code numbers of the respective reels 5L, 5C, and 5R correspond to code numbers of symbols to be repositioned on the pay line L. Therefore, when the game controller 100 determines code numbers of the respective reels 5L, 5C, and 5R, a symbol combination in a target game is determined. For example, in case code numbers of the reels 5L, 5C, and 5R are determined as “21”, “21”, and “21”, respectively, a symbol combination the game controller 100 has determined corresponds to three “RED7” symbols. Thus, by determining code numbers directed to the respective reels 5L, 5C, and 5R, a symbol combination lottery (see FIG. 5) is carried out.

At S14, the game controller 100 carries out a symbol display control processing.

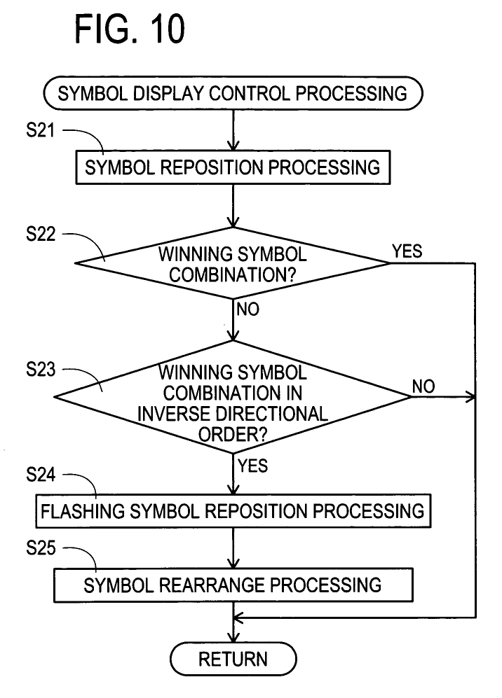

There will be described a subroutine concerning the symbol display control processing at S14 by referring to FIG. 10. FIG. 10 shows a flowchart of the symbol display control processing carried out in the slot machine 1 directed to the present embodiment. It is to be noted that programs executed in the flowchart of FIG. 10 are stored in the ROM 42 or the RAM 43 and executed by the game controller 100.

As shown in FIG. 10, the game controller 100 carries out a symbol reposition processing at S21. The symbol reposition processing is to control to stop spinning of the reels 5L, 5C, and 5R so as to reposition a symbol combination determined at the base game lottery processing (S13) on the pay line L. This processing is carried out between the game controller 100 and the graphic board 68.

To be more specific, the game controller 100 sends the graphic board 68 a start signal to start spinning of the reels. Upon receiving the start signal, the graphic board 68 carries out a spinning-reel-image display processing. That is, the graphic board 68 carries out display control and starts displaying a motion image of spinning reels 5L, 5C, and 5R in the lower-side image display panel 6.

After sending the start signal, the game controller 100 determines effects to be carried out in a game (e.g., image to be displayed in the upper-side image display panel 7 and sound to be outputted from the speaker 28) and starts carrying out effects in accordance with the determined effect manner.

When comes a predetermined timing to stop spinning of the reels 5L, 5C, and 5R, the game controller 100 sends code numbers of the respective reels to the graphic board 68. The graphic board 68 carries out a stopped-reel-image display processing in accordance with the code numbers assigned to the respective reels. Thereby, symbols associated with a lottery result at S13 are repositioned on the pay line L which runs across the display windows 10L, 10C, and 10R in the lower-side image display panel 6.

Next, at S22, the game controller 100 judges whether or not a symbol combination on the pay line L coincides with a winning symbol combination. That is, a forward (left-to-right) directional arrangement ordered symbol combination on the pay line L is specified by referring to respective code numbers of the reels stored on the RAM 43. After that, it is judged whether or not the specified symbol combination on the pay line L coincides with any one of winning symbol combinations defined in forward (left-to-right) directional arrangement order shown in FIG. 5. In case the forward directional arrangement ordered symbol combination coincides with a winning symbol combination defined in forward directional arrangement order (S22: YES), the processing returns to the main game processing in FIG. 9. In case it does not coincide with a winning symbol combination (S22: NO), the processing goes on to S23.

It is to be noted that this result is stored in the RAM 43.

Next, at S23, the game controller 100 judges whether or not the symbol combination in inverse directional arrangement order coincides with a winning symbol combination. That is, an inverse (right-to-left) directional arrangement ordered symbol combination on the pay line L is specified by referring to respective code numbers of the reels stored in the RAM 43. It is judged whether or not the specified symbol combination on the pay line L coincides with any one of winning symbol combinations of FIG. 5 defined in inverse (right-to-left) directional arrangement order. In case the inverse directional arrangement ordered symbol combination does not coincides with an inverse directional arrangement ordered winning symbol combination (S23: NO), the processing returns to the main game processing in FIG. 9. In case it coincides with a winning symbol combination (S23: YES), the processing goes on to S24.

For example, a symbol combination consisting of “BLUE7”, “BLUE7”, “CHERRY” in forward directional arrangement order on the pay line L shown at the left top stage of FIG. 1 is judged as not coinciding with any one of winning symbol combinations at S22 (S22: NO). However, at S23, the above symbol combination is judged as coinciding with a winning symbol combination consisting of “CHERRY”, (ANY), (ANY), (S23: YES).

It is to be noted that this result is stored in the RAM 43.

Going on to S24, the game controller 100 carries out a flashing symbol display processing. At the flashing symbol display processing, three symbols repositioned on the pay line L are made to flash one by one in inverse (right-to-left) directional arrangement order with reference to the pay line L. For example, as shown at the middle stage of FIG. 1, the three symbols of “BLUE7”, “BLUE7”, “CHERRY” repositioned on the pay line L are made to flash one by one in inverse (right-to-left) directional arrangement order with reference to the pay line L, i.e., they are made to flash in order of “CHERRY”, “BLUE7”, “BLUE7”. It is to be noted that this processing is carried out by the graphic board 68 in accordance with a display control signal from the game controller 100.

Going on to S25, the game controller 100 carries out a symbol rearrange processing. At the symbol rearrange processing, only the three symbols repositioned on the pay line L are rearranged on the pay line L by reversing the current arrangement order of the three symbols on the pay line L. For example, as shown at the lower stage of FIG. 1, only the three symbols of “BLUE7”, “BLUE7”, “CHERRY” currently repositioned on the pay line L are reversed and rearranged in reversed order of “CHERRY”, “BLUE7”, “BLUE7” on the pay line L. Accordingly, this processing is to rearrange three symbols currently arranged in forward (left-to-right) directional arrangement order on the pay line L in reversed order on the pay line L. It is to be noted that this processing is carried out by the graphic board 68 in accordance with a display control signal from the game controller 100.

After that, returning to the main game processing in FIG. 9, the game controller 100 judges whether or not a symbol combination coincides with a winning symbol combination at S15. This judgment is made based on a judgment result made at S22 or S23 and stored in the RAM 43. That is, in case it has been judged that a symbol combination coincides with a winning symbol combination at S22 or S23, a same judgment is made at this step (S15: YES), and in case it has been judged that a symbol combination does not coincide with a winning symbol combination at both S22 and S23, it is also judged that the symbol combination does not coincide with a winning symbol combination at this step (S15: NO). In case of a winning symbol combination (S15: YES), the processing goes on to S16. In case of not a winning symbol combination (S15: NO), this program is executed again.

At S16, the game controller 100 judges whether or not a bonus game trigger is won in a base game. To be more specific, provided that the payout table of FIG. 5 is used, in case a symbol combination of three “RED7” symbols are repositioned on the pay line L, it is judged as winning a bonus game trigger.

In case of a bonus game trigger (S16: YES), the game controller 100 carries out an optional type bonus game processing at S17. Details of the bonus game processing will be omitted here. After that, including “after the judgment of not a bonus game trigger” (S16: NO), the game controller 100 carries out a payout processing (S18). At the payout processing, total payouts won in a base game and a bonus game are awarded to a player. A payout awarded in a base game should be either a payout for a forward (left-to-right) directional arrangement ordered symbol combination on the pay line L which coincides with a winning symbol combination or a payout for an inverse (right-to-left) directional arrangement ordered symbol combination on the pay line L which coincides with a winning symbol combination.

At the payout processing, a payout can be made with coins equivalent to amount of credits (1 credit per 1 coin) by pressing the CASHOUT button 15, or made with a bar-code ticket 25.

After the payout processing, the main game processing will be executed again.

It is to be noted that the present invention is not restricted to the above-described embodiment but, not to mention, it can be variously improved and changed within the scope not departing from the subject matter thereof.

For example, it is not necessary to keep symbols flashing (flashing symbol display processing of S24) even at the symbol rearrange processing of S25, different from the exemplary diagrams at the middle and lower stages of FIG. 1.

Furthermore, there may be a case to carry out either the flashing symbol display processing of S24 or the symbol rearrange processing of S25 or may be a case to carry out neither of them.

What is claimed is:

1. A slot machine comprising:
a display for displaying plural symbols on a pay line; and
a game controller programmed to operate with the display (a) to cause the display to reposition plural symbols on the pay line, and (b) to award a payout of a winning symbol combination in case either a combination of the plural symbols on the pay line in a forward directional arrangement order or a combination of the plural symbols on the pay line in an inverse directional arrangement order coincides with a winning symbol combination.

2. A slot machine according to claim 1, wherein, in case the combination of the plural symbols on the pay line in the forward directional arrangement order does not coincide with a winning symbol combination, the game controller is programmed to check whether or not the combination of the plural symbols on the pay line in the inverse directional arrangement order coincides with a winning symbol combination.

3. A slot machine according to claim 1, wherein, in case the combination of the plural symbols on the pay line in the forward directional arrangement order does not coincide with a winning symbol combination, the game controller is programmed to cause the display to carry out an effect to make the plural symbols on the pay line flash sequentially in inverse directional arrangement order with reference to the pay line.

4. A slot machine according to claim 1, wherein, in case the combination of the plural symbols on the pay line in the forward directional arrangement order does not coincide with a winning symbol combination, the game controller is programmed to cause the display to carry out an effect to reverse current arrangement order of the plural symbols on the pay line and to rearrange the plural symbols on the pay line in reversed order.

5. A slot machine comprising:
a display for displaying plural symbols on a pay line; and
a game controller programmed to operate with the display (a) to cause the display to reposition plural symbols on the pay line, (b) to award a payout of a winning symbol combination in case a combination of the plural symbols on the pay line in a forward directional arrangement order coincides with a winning symbol combination, and (c) to award a payout of a winning symbol combination in case the combination of the plural symbols on the pay line in the forward directional arrangement order does not coincides with a winning symbols combination and the game controller has finished (1) checking whether or not the combination of the plural symbols on the pay line in the inverse directional arrangement order coincides with a winning symbol combination, (2) causing the display to carry out an effect to make the plural symbols on the pay line flash sequentially in inverse directional arrangement order, and (3) obtaining a check result of (1) such that the combination of the plural symbols on the pay line in the inverse directional arrangement order coincides with a winning symbol combination.

6. A slot machine comprising:
a display for displaying plural symbols on a pay line; and
a game controller programmed to operate with the display (a) to cause the display to reposition plural symbols on the pay line, (b) to award a payout of a winning symbol combination in case a combination of the plural symbols on the pay line in a forward directional arrangement order coincides with a winning symbol combination, and (c) to award a payout of a winning symbol combination in case the combination of the plural symbols on the pay line in the forward directional arrangement order does not coincides with a winning symbols combination and the game controller has finished (1) checking whether or not the combination of the plural symbols on the pay line in the inverse directional arrangement order coincides with a winning symbol combination, (2) causing the display to carry out an effect to reverse current arrangement order of the plural symbols on the pay line and to rearrange the plural symbols on the pay line in reversed order, and (3) obtaining a check result of (1) such that the combination of the plural symbols on the pay line in the inverse directional arrangement order coincides with a winning symbol combination.

7. A slot machine comprising:
a display for displaying plural symbols on a pay line; and
a game controller programmed to operate with the display (a) to cause the display to reposition plural symbols on the pay line, (b) to award a payout of a winning symbol combination in case a combination of the plural symbols on the pay line in a forward directional arrangement order coincides with a winning symbol combination, and (c) to award a payout of a winning symbol combination in case the combination of the plural symbols on the pay line in the forward directional arrangement order does not coincides with a winning symbols combination and the game controller has finished (1) checking whether or not the combination of the plural symbols on the pay line in the inverse directional arrangement order coincides with a winning symbol combination, (2) causing the display to carry out an effect to make the plural symbols on the pay line flash sequentially in inverse directional arrangement order with reference to the pay line and further carry out an effect to reverse current arrangement order of the plural symbols on the pay line and to rearrange the plural symbols on the pay line in reversed order, and (3) obtaining a check result of (1) such that the combination of the plural symbols on the pay line in the inverse directional arrangement order coincides with a winning symbol combination.

8. A method of playing a slot machine in which a game controller repeats a game by causing a display to display plural symbols on a pay line, the method comprising the steps of:
(a) causing display to reposition plural symbols on the pay line by the game controller; and
(b) awarding a pay out of winning symbol combination by the game controller in case either a combination of the plural symbols on the pay line in a forward directional arrangement order or a combination of the plural symbols on the pay line in an inverse directional arrangement order coincides with a winning symbol combination.

9. A method of playing a slot machine according to claim 8, wherein, in case the combination of the plural symbols on the pay line in the forward directional arrangement order does not coincide with a winning symbol combination, the step (b) further comprising a step of checking whether or not the combination of the plural symbols on the pay line in the inverse directional arrangement order coincides with a winning symbol combination by the game controller.

10. A method of playing a slot machine according to claim 8, wherein, in case the combination of the plural symbols on the pay line in the forward directional arrangement order does not coincide with a winning symbol combination, the step (b) further comprising a step of causing the display to carry out an effect to make the plural symbols on the pay line flash sequentially in inverse directional arrangement order with reference to the pay line by the game controller.

11. A method of playing a slot machine according to claim 8, wherein, in case the combination of the plural symbols on the pay line in the forward directional arrangement order does not coincide with a winning symbol combination, the step (b) further comprising a step of causing the display to carry out an effect to reverse current arrangement order of the plural symbols on the pay line and to rearrange the plural symbols on the pay line in reversed order by the game controller.

12. A method of playing a slot machine in which a game controller repeats a game by causing a display to display plural symbols on a pay line, the method comprising the steps of:
(a) causing display to reposition plural symbols on the pay line by the game controller;
(b) awarding a payout of a winning symbol combination in case a combination of the plural symbols on the pay line in a forward directional arrangement order coincides with a winning symbol combination by the game controller, and
(c) awarding a payout of a winning symbol combination by the game controller in case the combination of the plural symbols on the pay line in the forward directional arrangement order does not coincides with a winning symbols combination and the game controller has finished (1) checking whether or not the combination of the plural symbols on the pay line in the inverse directional arrangement order coincides with a winning symbol combination, (2) causing the display to carry out an effect to make the plural symbols on the pay line flash sequentially in inverse directional arrangement order, and (3) obtaining a check result of (1) such that the combination of the plural symbols on the pay line in the inverse directional arrangement order coincides with a winning symbol combination.

13. A method of playing a slot machine in which a game controller repeats a game by causing a display to display plural symbols on a pay line, the method comprising the steps of:
(a) causing display to reposition plural symbols on the pay line by the game controller;
(b) awarding a payout of a winning symbol combination by the game controller in case a combination of the plural symbols on the pay line in a forward directional arrangement order coincides with a winning symbol combination, and
(c) awarding a payout of a winning symbol combination by the game controller in case the combination of the plural symbols on the pay line in the forward directional arrangement order does not coincides with a winning symbols combination and the game controller has finished (1) checking whether or not the combination of the plural symbols on the pay line in the inverse directional arrangement order coincides with a winning symbol combination, (2) causing the display to carry out an effect to reverse current arrangement order of the plural symbols on the pay line and to rearrange the plural symbols on the pay line in reversed order, and (3) obtaining a check result of (1) such that the combination of the plural symbols on the pay line in the inverse directional arrangement order coincides with a winning symbol combination.

14. A method of playing a slot machine in which a game controller repeats a game by causing a display to display plural symbols on a pay line, the method comprising the steps of:
(a) causing display to reposition plural symbols on the pay line by the game controller;
(b) awarding a payout of a winning symbol combination by the game controller in case a combination of the plural symbols on the pay line in a forward directional arrangement order coincides with a winning symbol combination, and
(c) awarding a payout of a winning symbol combination by the game controller in case the combination of the plural symbols on the pay line in the forward directional arrangement order does not coincides with a winning symbols combination and the game controller has finished (1) checking whether or not the combination of the plural symbols on the pay line in the inverse directional arrangement order coincides with a winning symbol combination, (2) causing the display to carry out an effect to make the plural symbols on the pay line flash sequentially in inverse directional arrangement order with reference to the pay line and further carry out an effect to reverse current arrangement order of the plural symbols on the pay line and to rearrange the plural symbols on the pay line in reversed order, and (3) obtaining a check result of (1) such that the combination of the plural symbols on the pay line in the inverse directional arrangement order coincides with a winning symbol combination.
